(19) United States
(12) Patent Application Publication
(10) Pub. No.: US 2020/0319080 A1
(43) Pub. Date: Oct. 8, 2020

(54) CONNECTING MEMBER AND MICROPARTICLE MEASURING APPARATUS

(71) Applicant: SONY CORPORATION, TOKYO (JP)

(72) Inventors: YOSHITSUGU SAKAI, KANAGAWA (JP); MASAAKI ABE, KANAGAWA (JP); ICHIRO FUJII, CHIBA (JP); RYOICHI KUBOTA, CHIBA (JP)

(21) Appl. No.: 16/305,879

(22) PCT Filed: Apr. 12, 2017
(86) PCT No.: PCT/JP2017/014975

§ 371 Date: Nov. 29, 2018

(30) Foreign Application Priority Data
Jun. 10, 2016 (JP) 2016-116692

(51) Int. Cl. G01N 15/14; B01L 3/00

(52) U.S. Cl. CPC G01N 15/1434; G01N 15/1404; B01L 2200/0647; G01N 2015/149; G01N 2015/1409; B01L 3/502

(57) ABSTRACT

There is provided a connecting member to be attached to a substrate that includes at least a sample introduction section to introduce a sample, a sheath liquid introduction section to introduce a sheath liquid, and a jetting section to jet droplets, the connecting member including at least: a sample introduction linking section to be linked to the sample introduction section; a sheath liquid introduction linking section to be linked to the sheath liquid introduction section; and a charging electrode section that provides charges to at least part of the droplets. The sample introduction linking section and the sheath liquid introduction linking section are positioned so as to be linked to corresponding positions of the substrate.

### CROSS REFERENCE TO RELATED APPLICATIONS

This application claims the benefit of Japanese Priority Patent Application JP 2016-116692 filed Jun. 10, 2016, the entire contents of which are incorporated herein by reference.

### TECHNICAL FIELD

The present technology relates to a connecting member and a microparticle measuring apparatus.

### BACKGROUND ART

In recent years, studies on regenerative medicine and cell therapy are actively underway, and a need for a flow cytometer as a method of quickly evaluating cells is increasing. A flow cytometer is an analysis method for analyzing and sorting microparticles by introducing microparticles to be analyzed into a fluid stream in the state of being aligned, and irradiating the microparticles with laser light or the like to detect fluorescence and scattered light emitted from the microparticles. Such a flow cytometer is used as a tool for analyzing cells in the studies on regenerative medicine and cell therapy. In these studies, a risk that cells may be contaminated is necessary to be reduced. Accordingly, there is a demand for a flow cytometer which allows for processing in a sterile environment.

Here, there has been known a problem in that continuous sorting of numerous various microparticles with one flow cytometer may cause microparticles contained in a previously sorted fluid flow to be remained in constituent components, leading to contamination when sorting is performed in a subsequent different fluid flow.

To address such a problem, there has been proposed, for example, as disclosed in Patent Literature 1, a system of analyzing cell particles contained in a liquid flow, including: a fluid flow formation block constituting a flow cell which contains a flow channel and a flow chamber to receive a sample liquid conductor; and a strobe block having an imaging section that takes images of predetermined regions in jet flow jetted out of the fluid flow formation block and a plurality of droplets. The fluid flow formation block and the strobe block are detachably fixed to the system.

### CITATION LIST

### Patent Literature

[PTL 1]

JP 2011-232033A

### SUMMARY

In some embodiments, a connecting member is configured to be releasably attachable to a substrate that includes at least a sample introduction section to receive a sample, a sheath liquid introduction section to receive a sheath liquid to be merged with the sample to form a laminar flow, and a jetting section to jet droplets of fluid from the laminar flow. The connecting member comprises at least a sample introduction linking section, a sheath liquid introduction linking section, and a charging electrode section. The sample introduction linking section is configured and positioned to be releasably linked to the sample introduction section of the substrate so as to allow a sample received by the connecting member to pass from the sample introduction linking section to the sample introduction section of the substrate. The sheath liquid introduction linking section is configured and positioned to be releasably linked to the sheath liquid introduction section of the substrate so as to allow a sheath liquid received by the connecting member to pass from the sheath liquid introduction linking section to the sheath liquid introduction section of the substrate. The charging electrode section is configured and arranged to provide charges from a charging circuit to at least part of the droplets.

In some embodiments, a connecting member is configured to be attached to a substrate that includes at least a sample introduction section to introduce a sample, a sheath liquid introduction section to introduce a sheath liquid, and a jetting section to jet droplets. The connecting member includes at least: a sample introduction linking section to be linked to the sample introduction section; a sheath liquid introduction linking section to be linked to the sheath liquid introduction section; and a charging electrode section that provides charges to at least part of the droplets. The sample introduction linking section and the sheath liquid introduction linking section are positioned so as to be linked to corresponding positions of the substrate.

### Technical Problem

Meanwhile, a flow cytometer including a disposable microchip is recently developed. Accordingly, the risk of contamination is necessary to be reduced not only in the microchip portion through which microparticles flow, but also in a member around the microchip portion.

To address this concern, it is desirable to provide a technology which can reduce the risk of contamination.

### Solution to Problem

A first embodiment of the present technology provides a connecting member to be releasably attached to a substrate that includes at least a sample introduction section to receive a sample, a sheath liquid introduction section to receive a sheath liquid to be merged with the sample to form a laminar flow, and a jetting section to jet droplets of fluid from the laminar flow. The connecting member comprises at least a sample introduction linking section, a sheath liquid introduction linking section, and a charging electrode section. The sample introduction linking section is configured and positioned to be releasably linked to the sample introduction section of the substrate so as to allow a sample received by the connecting member to pass from the sample introduction linking section to the sample introduction section of the substrate. The sheath liquid introduction linking section is configured and positioned to be releasably linked to the sheath liquid introduction section of the substrate so as to allow a sheath liquid received by the connecting member to pass from the sheath liquid introduction linking section to the sheath liquid introduction section of the substrate. The charging electrode section is configured and arranged to provide charges from a charging circuit to at least part of the droplets.

In the connecting member according to the first embodiment of the present technology, the charging electrode section may be in contact with the sheath liquid introduction linking section to provide charges to at least part of the droplets through the sheath liquid.

In the connecting member according to the first embodiment of the present technology, the charging electrode section may include a connection section that is connected to a charging section, and a contact section that is in contact with the sheath liquid introduction linking section.

In this case, the connection section and the contact section may both include metal.

In the connecting member according to the first embodiment of the present technology, the substrate may further includes a suction opening to discharge a drain liquid, and the connecting member may further include a drain liquid linking section configured and positioned to be releasably linked to the suction opening of the substrate so as to allow a drain liquid within the substrate to pass from the suction opening of the substrate to the drain liquid linking section of the connecting member.

In this case, the drain liquid linking section may include a drain liquid tube to discharge liquid to a drain liquid section.

In the connecting member according to the first embodiment of the present technology, the sheath liquid introduction linking section may include a liquid delivering tube to deliver liquid from a sheath liquid delivering section.

In this case, the liquid delivering tube may include an inter-tube linking section configured and positioned to be directly linked to the sheath liquid delivering section.

The inter-tube linking section may be configured such that a liquid in the liquid delivering tube does not contact outside air.

In the connecting member according to the first embodiment of the present technology, the sample introduction linking section may further include a tube fixing section that fixes a liquid delivering tube to deliver liquid from a sample liquid delivering section.

In the connecting member according to the first embodiment of the present technology, the connecting member may further comprise a positioning mechanism configured and positioned to accurately position the connecting member with respect to a microparticle measuring apparatus.

In this case, the positioning mechanism may comprise a screw fixing mechanism.

The connecting member may move in a direction going away from the substrate when the screw rotates in a direction of being pushed toward the substrate.

In the connecting member according to the first embodiment of the present technology, the connecting member may further comprise a chip positioning mechanism configured and positioned to accurately position a microparticle measuring chip with respect to the connecting member.

In the connecting member according to the first embodiment of the present technology, the connecting member may be provided in combination with a microparticle measuring apparatus to which the connecting member is attached.

The connecting member may further be provided in combination with the substrate, with the sample introduction linking section being releasably linked to the sample introduction section of the substrate, and the sheath liquid introduction linking section being releasably linked to the sheath liquid introduction section of the substrate.

In any of the above combinations, the microparticle sorting apparatus may comprise a fluid controller configured to control the introduction of the sheath liquid to the sheath liquid introduction section.

In this case, the substrate may further include a suction opening to discharge a drain liquid, the connecting member may further include a drain liquid linking section configured and positioned to be releasably linked to the suction opening of the substrate so as to allow a drain liquid within the substrate to pass from the suction opening of the substrate to the drain liquid linking section of the connecting member, and the fluid controller may be further configured to control the discharge of the drain liquid from drain liquid linking section.

In any of the above combinations, the microparticle sorting apparatus may further comprise a light irradiation section configured to irradiate microparticles of the sample with light, and a light detector to detect light generated from the microparticles in response to the light from the light irradiation section.

In this case, the microparticle sorting apparatus may further comprise an analyzer configured to analyze light detected by the light detector to identify at least one characteristic of the microparticles in the sample.

The microparticle sorting apparatus may further comprise a sorting section including a vibration element configured to cause droplets to be generated from the laminar flow, and a deflector configured to change a moving direction of droplets to which charges were added via the charging electrode section of the connecting member based on a sorting control signal generated by the analyzer.

In any of the above combinations, the microparticle sorting apparatus may further comprise a sorting section including a vibration element configured to cause droplets to be generated from the laminar flow, and a deflector configured to change a moving direction of droplets to which charges were added via the charging electrode section of the connecting member.

A second embodiment of the present technology provides a connecting member to be attached to a substrate that includes at least a sample introduction section to introduce a sample, a sheath liquid introduction section to introduce a sheath liquid, and a jetting section to jet droplets, the connecting member including at least: a sample introduction linking section to be linked to the sample introduction section; a sheath liquid introduction linking section to be linked to the sheath liquid introduction section; and a charging electrode section that provides charges to at least part of the droplets. The sample introduction linking section and the sheath liquid introduction linking section are positioned so as to be linked to corresponding positions of the substrate.

In the connecting member according to the second embodiment of the present technology, the charging electrode section may be contacted to the sheath liquid introduction linking section to provide charges to at least part of the droplets through a sheath liquid.

In the connecting member according to the second embodiment of the present technology, the charging electrode section may include a connection section that is connected to a charging section, and a contact section that is contacted to the sheath liquid introduction linking section.

In this case, the connection section and the contact section may include metal.

In the connecting member according to the second embodiment of the present technology, the substrate may further include a suction opening to discharge a drain liquid, the connecting member may further include a drain liquid linking section to be linked to the suction opening, and the drain liquid linking section may be positioned so as to be linked to a corresponding position of the substrate.

In the connecting member according to the second embodiment of the present technology, the sheath liquid introduction linking section may include a liquid delivering tube to deliver liquid from a sheath liquid delivering section.

In this case, the liquid delivering tube may include an inter-tube linking section to be directly linked to the sheath liquid delivering section.

The inter-tube linking section may be configured such that a liquid in the liquid delivering tube is not contacted to outside air.

In the connecting member according to the second embodiment of the present technology, the sample introduction linking section may further include a tube fixing section that fixes a liquid delivering tube to deliver liquid from a sample liquid delivering section.

In the connecting member according to the second embodiment of the present technology, a drain liquid linking section may include a drain liquid tube to discharge liquid to a drain liquid section.

In the connecting member according to the second embodiment of the present technology, a positioning mechanism capable of positioning with respect to a microparticle measuring apparatus may be further included.

In this case, the positioning mechanism may be a screw fixing mechanism.

The connecting member may move in a direction of going away from the substrate when the screw rotates in a direction of being pushed toward the substrate side.

In the connecting member according to the second embodiment of the present technology, a chip positioning mechanism capable of positioning a microparticle measuring chip may be further included.

The second embodiment of the present technology may also provide a microparticle measuring apparatus to which the connecting member according to the second embodiment of the present technology is attached.

In the present technology, the term “microparticle” has a broad meaning that includes biologically relevant microparticles such as cells, microbes and ribosomes, synthetic particles such as latex particles, gel particles and industrial particles, and the like.

Examples of biologically relevant microparticles include chromosomes, liposomes, mitochondria, organelles (cell organelles), which constitute various cells. Examples of cells include animal cells (for example, hematopoietic cells) and plant cells. Examples of microbes include bacteria such as E. coli, viruses such as tobacco mosaic virus, and fungi such as yeast. Further examples of biologically relevant microparticles may include biologically relevant high polymers such as nucleic acids, proteins, and complexes thereof. Examples of industrial particles may include organic or inorganic polymer materials and metal. Examples of organic polymer materials include polystyrene, styrene-divinylbenzene, and polymethyl methacrylate. Examples of inorganic polymer materials include glass, silica, and magnetic materials. Examples of metal include metal colloids and aluminum. In general, the shape of these microparticles is spherical. However, in the present technology, the microparticles may be non-spherical, and the size, mass, and the like thereof are not particularly limited.

### Advantageous Effects of Invention

According to an embodiment of the present technology, the risk of contamination can be reduced. It is noted that the effects described here are not necessarily limiting, and any one of the effects described in the present disclosure may be exerted.

### BRIEF DESCRIPTION OF DRAWINGS

FIG. 1 is a schematic diagram illustrating a first embodiment of a connecting member C according to the present technology.

FIG. 2 is a schematic diagram illustrating a second embodiment of a connecting member C according to the present technology.

FIG. 3 is a schematic end diagram of the connecting member C according to the second embodiment indicated in FIG. 2.

FIG. 4 is a schematic conceptual diagram schematically illustrating an embodiment of a microparticle measuring apparatus 100 according to the present technology.

FIG. 5A is a schematic diagram illustrating a configuration of a microparticle measuring chip M usable in the microparticle measuring apparatus 100 of FIG. 4.

FIG. 5B is a schematic diagram illustrating a configuration of a microparticle measuring chip M usable in the microparticle measuring apparatus 100 of FIG. 4.

FIG. 6A is a schematic diagram illustrating a configuration of an orifice M1 of the microparticle measuring chip M usable in the microparticle measuring apparatus 100 of FIG. 4.

FIG. 6B is a schematic diagram illustrating a configuration of an orifice M1 of the microparticle measuring chip M usable in the microparticle measuring apparatus 100 of FIG. 4.

FIG. 6C is a schematic diagram illustrating a configuration of an orifice M1 of the microparticle measuring chip M usable in the microparticle measuring apparatus 100 of FIG. 4.

FIG. 7 is a schematic diagram illustrating an embodiment of a sheath liquid delivering section 1.

FIG. 8 is a schematic diagram illustrating an embodiment of a fluid controller 102.

### DESCRIPTION OF EMBODIMENTS

Hereinafter, preferred embodiments of the present technology will be described with reference to the drawings. The embodiments described below are examples of a representative embodiment of the present technology, and do not cause the scope of the present technology to be narrowly interpreted. It is noted that description will be provided in the following order.
1. Connecting member C
2. Microparticle measuring apparatus 100
(1) Flow channel P
(1-1) Microparticle measuring chip M
(2) Sample liquid delivering section 101
(3) Fluid controller 102
(4) Connecting member C
(5) Light irradiation section 103
(6) Light detector 104
(7) Analyzer 105
(8) Sorting section 106
(9) Storage section 107
(10) Display section 108
(11) Input section 109
(12) Controller 110
(13) Others

1. Connecting Member C

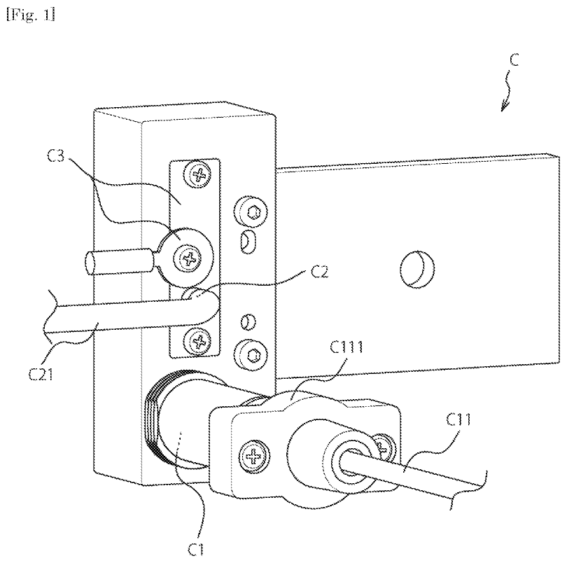

FIG. 1 is a schematic diagram illustrating a first embodiment of a connecting member C according to the present technology which can be attached to a substrate that includes at least a sample introduction section to introduce a sample, a sheath liquid introduction section to introduce a sheath liquid, and a jetting section to jet droplets. This connecting member C according to the first embodiment includes at least, as illustrated in FIG. 1, a sample introduction linking section C1 to be linked to the sample introduction section, a sheath liquid introduction linking section C2 to be linked to the sheath liquid introduction section, and a charging electrode section C3 to provide charges to at least part of the droplets. The sample introduction linking section C1 and the sheath liquid introduction linking section C2 are positioned so as to be linked to the corresponding positions of the substrate.

With the use of such a connecting member C according to an embodiment of the present technology which is detachable to the substrate, part of constituent articles of one device used for continuously sorting numerous various microparticles can be detachable. Therefore, even when microparticles contained in a previously sorted fluid flow remain in constituent articles, the constituent articles can be removed in its entirety, thereby reducing the risk of contamination. Furthermore, with the use of a microparticle measuring chip M described below, portions contacted with the chip M can be detachable. This can also reduce the risk of contamination. Moreover, when the microparticle measuring chip M described below and the connecting member C according to an embodiment of the present technology are disposable for each sample, time and labor for a washing operation performed at the time of changing a sample can be saved, and burdens on operators can be reduced.

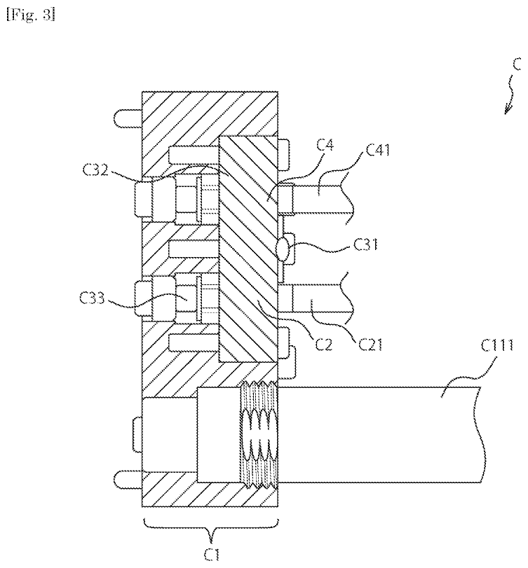

The charging electrode section C3 is contacted to the sheath liquid introduction linking section C2, and can provide charges to at least part of the droplets through a sheath liquid. The charging electrode section C3 may include, but not particularly limited to, as illustrated in FIG. 3, connection sections C31/C32 that are connected to a charging section 1061, and a contact section C33 that is contacted to the sheath liquid introduction linking section C2. Details of the charging section 1061 will be described later in (8) Sorting section 106.

The connection sections C31/C32 and the contact section C33 preferably include metal. It is noted that when the metal included in the connection sections C31/C32 and the contact section C33 is disposable for each sample, time and labor for a washing operation performed at the time of changing a sample can be similarly saved, and burdens on operators can be reduced.

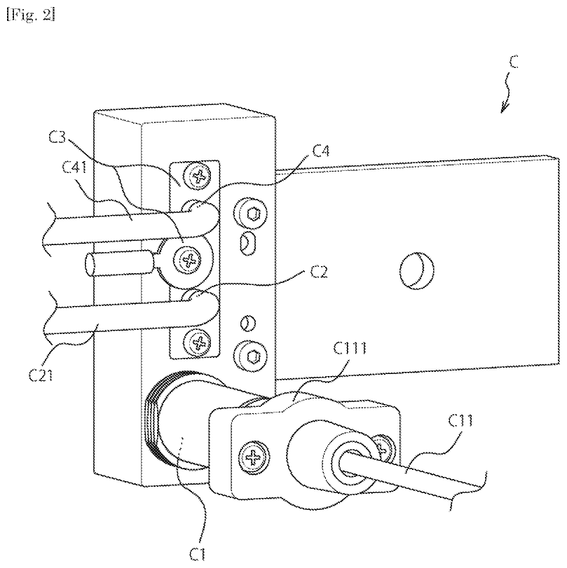

FIG. 2 is a schematic diagram illustrating a second embodiment of the connecting member C according to the present technology which can be attached to the substrate further having a suction opening to discharge drain liquid. FIG. 3 is an end schematic diagram of the connecting member C according to the second embodiment illustrated in FIG. 2. This connecting member C according to the second embodiment further includes a drain liquid linking section C4 to be linked to the suction opening as illustrated in FIGS. 2 and 3. The drain liquid linking section C4 is positioned so as to be linked to the corresponding position of the substrate. The further inclusion of the drain liquid linking section C4 enables the connecting member C according to an embodiment of the present technology to be also attached to the substrate having a drain liquid section.

Also, the sheath liquid introduction linking section C2 may include, as illustrated in FIGS. 1 to 3, a liquid delivering tube C21 to deliver liquid from a sheath liquid delivering section. Furthermore, the liquid delivering tube C21 may include an inter-tube linking section to be directly linked to the sheath liquid delivering section. In this case, the inter-tube linking section is preferably configured such that the liquid in the liquid delivering tube C21 is not contacted to outside air. This can secure the cleanness of a sheath liquid.

Furthermore, the sample introduction linking section C1 may include, as illustrated in FIGS. 1 to 3, a tube fixing section C111 to fix a liquid delivering tube C11 to deliver liquid from a sample liquid delivering section. In addition, the drain liquid linking section C4 may include, as illustrated in FIGS. 2 and 3, a drain liquid tube C41 to discharge liquid to the drain liquid section. This saves the time and labor for attaching and fixing tubes. Thus, operations during measurement can be prevented from being complicated, thereby reducing burdens on operators. Also, when these members are disposable for each sample, contamination can be prevented.

The liquid delivering tubes C11 and C21 and the drain liquid tube C41 can be disposed integrally with or separately from the connecting member C. For example, the liquid delivering tube C11 and the tube fixing section C111 to deliver liquid from the sample liquid delivering section may be detachable from the connecting member C, and connection with the sample liquid delivering section located in a position different from the sheath liquid delivering section and the drain liquid section is facilitated.

Also, the connecting member C according to an embodiment of the present technology may further include a positioning mechanism capable of positioning with respect to a microparticle measuring apparatus 100 described below. Accordingly, even the detachable connecting member C according to an embodiment of the present technology can be accurately positioned. Thus, the reduction in measurement accuracy attributable to misaligned placement of the connecting member C according to an embodiment of the present technology can be prevented.

The positioning mechanism may be, but not particularly limited to, a screw fixing mechanism. In this case, when removing the connecting member C according to an embodiment of the present technology, the rotation of a screw in the direction of being pressed toward the substrate side may cause the connecting member C according to an embodiment of the present technology to move in the direction of going away from the substrate. Accordingly, the removal of the connecting member C according to an embodiment of the present technology is facilitated, thereby reducing burdens on operators.

Furthermore, the connecting member C according to an embodiment of the present technology may further include a chip-positioning mechanism capable of positioning of a microparticle measuring chip M described below. Accordingly, accurate positioning is enabled, thereby preventing the reduction in measurement accuracy attributable to misaligned placement of the chip M.

The fixing of the substrate and the connecting member C according to an embodiment of the present technology to the microparticle measuring apparatus 100 as described above allows the microparticle measuring chip M described below to be inserted and fixed between the microparticle measuring apparatus 100 and the connecting member C according to an embodiment of the present technology.

2. Microparticle Measuring Apparatus 100

FIG. 4 is a schematic conceptual diagram schematically illustrating an embodiment of the microparticle measuring apparatus 100 according to the present technology. The microparticle measuring apparatus 100 according to an embodiment of the present technology at least includes the connecting member C according to an embodiment of the present technology attached thereto. The microparticle measuring apparatus 100 may further include, as necessary, a flow channel P, a sample liquid delivering section 101, a fluid controller 102, a light irradiation section 103, a light detector 104, an analyzer 105, a sorting section 106, a charging section 1061, a storage section 107, a display section 108, an input section 109, a controller 110, and the like.

In FIG. 4, the liquid delivering tube C11 to deliver liquid from the sample liquid delivering section 101, the liquid delivering tube C21 to deliver liquid from a sheath liquid delivering section 1, and the drain liquid tube C41 to discharge drain liquid to a drain liquid section 3 are detachable as necessary. These members may be disposable. Additionally, the microparticle measuring chip M described later may be similarly handled as necessary.

Hereinafter, each component will be described in detail.

(1) Flow Channel P

Although the flow channel P may be previously disposed to the microparticle measuring apparatus 100 according to an embodiment of the present technology, a commercially available flow channel P, a disposable chip including the flow channel P, or the like can be installed to the microparticle measuring apparatus 100 for analysis and sorting.

The form of the flow channel P usable in the microparticle measuring apparatus 100 according to an embodiment of the present technology is not particularly limited, and can be freely designed. Preferably, the flow channel P formed in a two-dimensional or three-dimensional substrate made of plastic, glass, and the like as illustrated in the microparticle measuring apparatus 100 of FIG. 4 can be used in the microparticle measuring apparatus 100 according to an embodiment of the present technology.

Also, the width, depth, and cross-sectional shape of the flow channel P are not particularly limited, and can be freely designed, as long as a laminar flow can be formed. For example, a micro flow channel having a width of 1 millimetre or less can also be used in the microparticle measuring apparatus 100 according to an embodiment of the present technology. In particular, a micro flow channel having a width of approximately 10 micrometres or more and 1 millimetre or less can be more suitably used in the microparticle measuring apparatus 100 according to an embodiment of the present technology.

(1-1) Microparticle Measuring Chip M

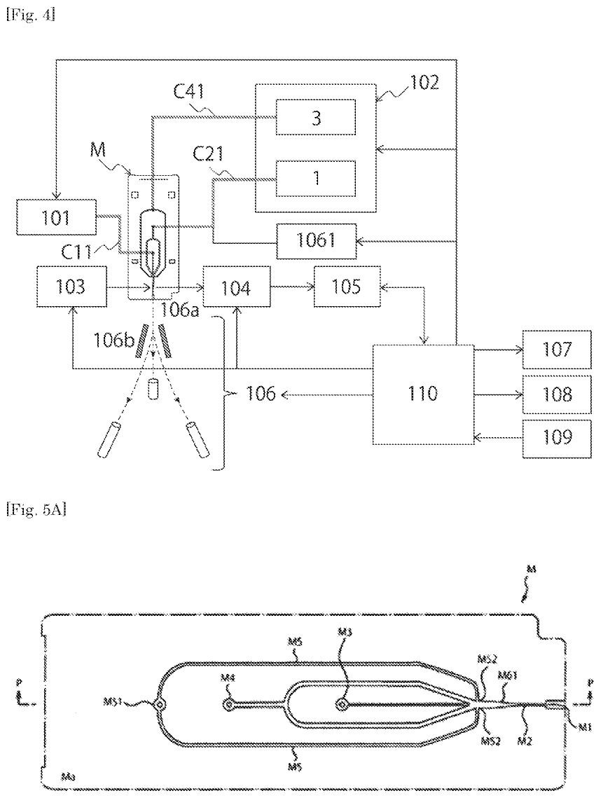

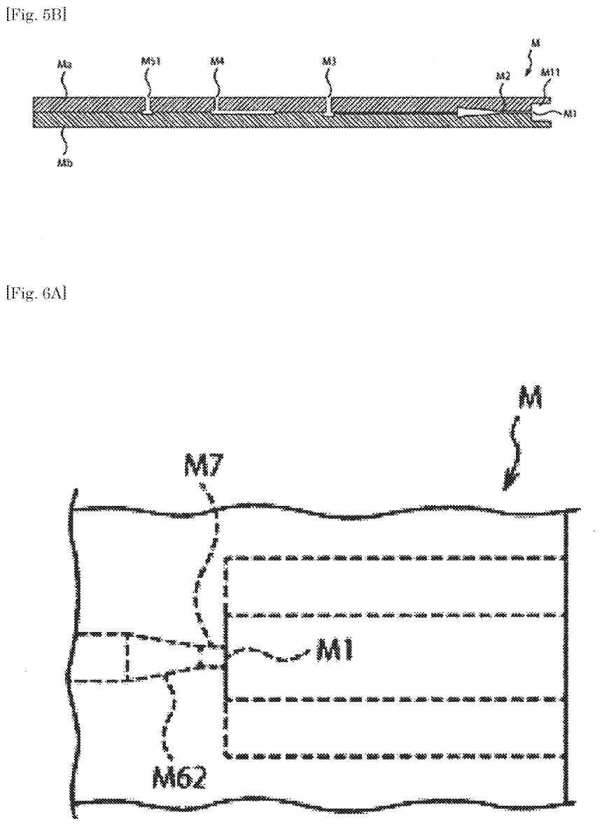

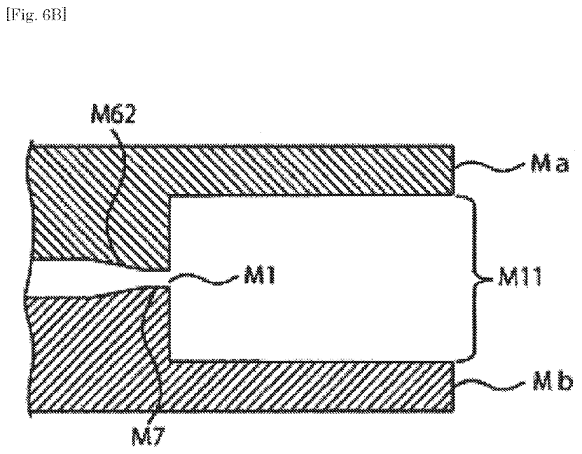

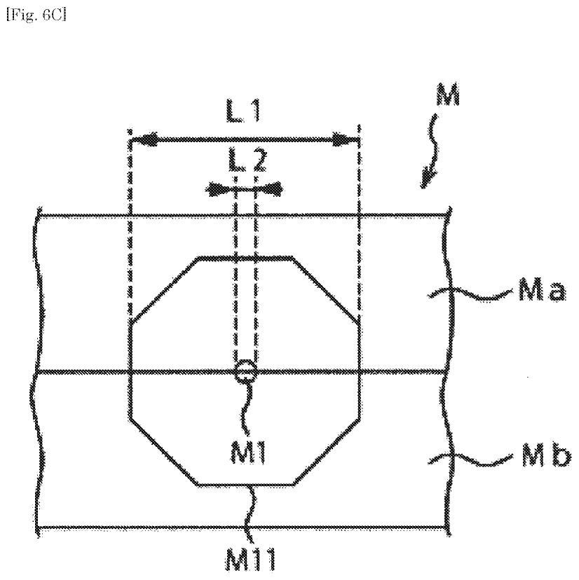

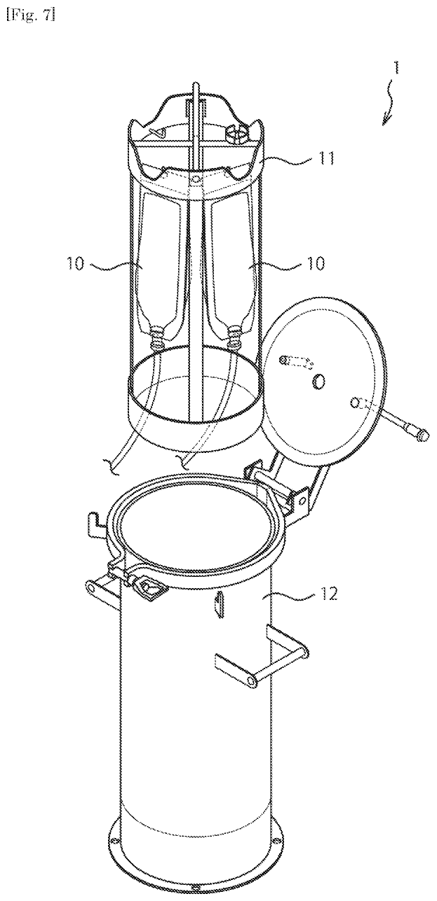

FIGS. 5A and 5B are each a schematic diagram illustrating a configuration of the microparticle measuring chip M usable in the microparticle measuring apparatus 100 of FIG. 4, and FIGS. 6A to 6C are each a schematic diagram illustrating a configuration of an orifice M1 of the microparticle measuring chip M usable in the microparticle measuring apparatus 100 of FIG. 4. FIG. 5A is a top schematic diagram, and FIG. 5B is a cross-sectional schematic diagram taken along a P-P cross section in FIG. 5A. Also, FIG. 6A is a top diagram, FIG. 6B is a cross-sectional diagram, and FIG. 6C is a front diagram. It is noted that FIG. 6B corresponds to the P-P cross section in FIG. 5A.

The microparticle measuring chip M is obtained by bonding substrate layers Ma and Mb on which a sample flow channel M2 is formed. The sample flow channel M2 can be formed on the substrate layers Ma and Mb by injection molding with thermoplastic resin using a molding die. As the thermoplastic resin, any plastic known as materials for a microparticle measuring chip may be adopted. Examples of such plastic include polycarbonate, polymethyl methacrylate resin (PMMA), cyclic polyolefin, polyethylene, polystyrene, polypropylene, and polydimethylsiloxane (PDMS).

Also, the microparticle measuring chip M includes a sample introduction section M3 to introduce a sample containing microparticles, a sheath liquid introduction section M4 to introduce a sheath liquid, and the sample flow channel M2 where a sample flow is introduced and merges with the sheath liquid. A sheath liquid introduced from the sheath liquid introduction section M4 is divided into two and delivered in the two directions, and thereafter merges with a sample liquid introduced from the sample introduction section M3 at a confluence with the sample liquid, in such a manner that the sample liquid is sandwiched by the sheath liquid from the two directions. Accordingly, a three-dimensional laminar flow in which a sample liquid laminar flow is located in the center of a sheath liquid laminar flow is formed at the confluence.

In FIG. 5A, M5 indicates a suction flow channel for eliminating cloggings and air bubbles generated in the sample flow channel M2 by applying negative pressure in the sample flow channel M2 to temporarily reverse currents. A suction opening M51 to be connected to a negative pressure source such as a vacuum pump is formed on one end of the suction flow channel M5. The other end of the suction flow channel M5 is connected to the sample flow channel M2 at a communication opening M52.

The three-dimensional laminar flow is narrowed in width at narrowing portions M61 (see FIG. 5) and M62 (see FIG. 6A and FIG. 6B) in which the area of the cross section vertical to the liquid delivering direction decreases in a gradual or stepwise manner from the upstream side to the downstream side in the liquid delivering direction. Thereafter, the three-dimensional laminar flow is discharged as a fluid stream from the orifice M1 disposed on one end of the flow channel.

The fluid stream ejected from the orifice M1 is transformed into droplets by vibration applied to the orifice M1 with a vibration element 106a described below. The orifice M1 opens in the direction of the ends of the substrate layers Ma and Mb, and a cutout M11 is disposed between the opening location and the ends of the substrate layers. The cutout M11 is formed by cutting out the substrate layers Ma and Mb between the opening location of the orifice M1 and the ends of the substrates, such that a diameter L1 of the cutout M11 is more than an opening diameter L2 of the orifice M1 (see FIG. 6C). The diameter L1 of the cutout M11 is preferably not less than twice the opening diameter L2 of the orifice M1, such that the movement of the droplets jetted from the orifice M1 is not inhibited.

(2) Sample Liquid Delivering Section 101

The sample liquid delivering section 101 delivers a sample to the sample introduction section M3 through the above-described sample liquid delivering tube and the sample introduction linking section C1. For example, the sample liquid delivering section 101 may suck and deliver a sample from a test tube, a well plate, or the like containing the sample therein, through a nozzle. Alternatively, the sample liquid delivering section 101 may apply pressure to a housing section capable of housing a test tube or the like containing a sample therein for delivering the sample as a liquid.

(3) Fluid Controller 102

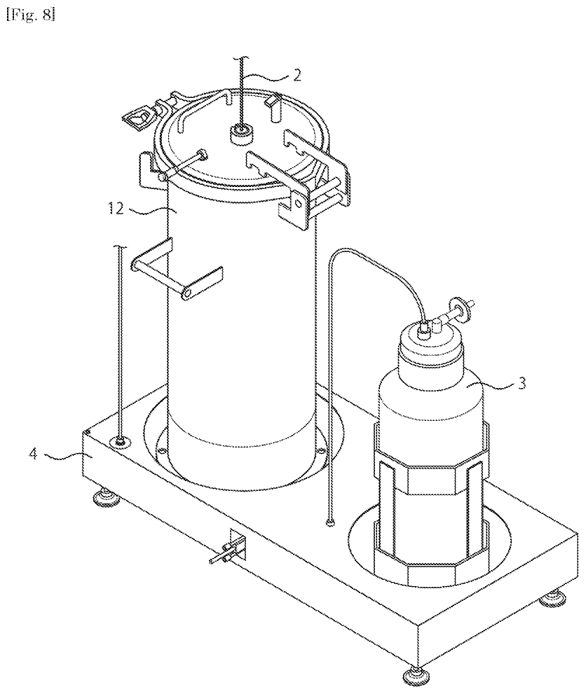

The fluid controller 102 includes the sheath liquid delivering section 1 to introduce a sheath liquid to the sheath liquid introduction section M4. FIG. 7 is a schematic diagram illustrating an embodiment of the sheath liquid delivering section 1 including a support 11 to which a sheath liquid housing section 10 can be attached, and a sealing section 12. For example, a sheath liquid in the sheath liquid housing section 10 is delivered to the sheath liquid introduction section M4 through a sheath liquid delivering tube 2 and the sheath liquid introduction linking section C2 described above with pressure to the sealing section 12.

The sheath liquid delivering tube 2 includes an engaging section that engages with a through hole of the sealing section 12. The engaging section can be integrated with the above-described inter-tube linking section.

FIG. 8 is a schematic diagram illustrating an embodiment of the fluid controller 102. The fluid controller 102 further includes the drain liquid section 3. For example, cloggings and air bubbles in the sample flow channel M2 are collected from the suction opening M51 through the drain liquid tube and the drain liquid linking section C4 as described above by pumping functions. Also, the drain liquid section 3 can be connected to the sorting section 106 for sucking the droplets, aerosols, and the like which have not been sorted in the sorting section 106 described below.

Also, the fluid controller 102 may include, as illustrated in FIG. 8, a mounting board 4 on which the sheath liquid delivering section 1 and the drain liquid section 3 can be mounted. A drain liquid controller can be disposed to the mounting board 4. Alternatively, the drain liquid controller can be disposed, as one of the controllers 110 described below, to a location other than the mounting board 4.

The fluid controller 102 may be formed separately from the microparticle measuring apparatus 100, or may be formed as part of the microparticle measuring apparatus 100.

(4) Connecting Member C

Since the connecting member C has been described above, detailed description is omitted here. In the microparticle measuring apparatus 100 of FIG. 4, the microparticle measuring chip M and each of the sample liquid delivering section 101 and the fluid controller 102 are connected via the connecting member C.

(5) Light Irradiation Section 103

The light irradiation section 103 irradiates microparticles to be analyzed with light. The light emitted from the light irradiation section 103 is preferably, but not particularly limited to, light having a constant optical direction, wavelength, and light intensity, in order to cause fluorescent light and scattered light to be reliably generated from the particles. Specific examples of such light may include laser and LED. The laser to be used is also not particularly limited. Examples of the laser may include any one or any combination of two or more of argon ion (Ar) laser, helium-neon (He—Ne) laser, dye laser, krypton (Cr) laser, semiconductor laser, and solid-state laser including a combination of semiconductor laser and a wavelength conversion optical element.

(6) Light Detector 104

The light detector 104 detects light generated from the microparticles. The light detector 104 detects optical components such as fluorescent light, forward scattered light, and backscattered light which are generated from the microparticles in response to the light irradiation of microparticles by the light irradiation section 103. Such fluorescent light and necessary scattered light components are important optical components for obtaining optical data (properties) of microparticles.

The light detector 104 is not particularly limited, and can be freely selected from known optical detectors, as long as it can detect light from microparticles. Examples of the light detector 104 to be adopted may include any one or any combination of two or more of a fluorescence measuring device, a scattered light measuring device, a transmitted light measuring device, a reflected light measuring device, a diffracted light measuring device, an ultraviolet spectrometer, an infrared spectrometer, a Raman spectrometer, an FRET measuring device, a FISH measuring device, other various spectrum measuring devices, and a so-called multi-channel optical detector constituted by an array of multiple optical detectors.

In the present technology, it is preferable that the light detector 104 includes a light receiving element which receives light generated from microparticles. Examples of the light receiving element may include an area imaging element such as CCD and CMOS elements, a PMT, and a photodiode.

Furthermore, the light detector 104 may be constituted by a plurality of light receiving elements each having a different detection wavelength range. When the light detector 104 is constituted by the plurality of light receiving elements each having a different detection wavelength range, light intensities in consecutive wavelength ranges can be measured as a fluorescence spectrum. Specific examples of such a configuration may include a PMT array or a photodiode array in which light receiving elements are linearly arranged, and aligned multiple separate detection channels such as two-dimensional light receiving elements such as CCDs and CMOSs.

(7) Analyzer 105

The analyzer 105 is connected to the light detector 104, and analyzes light detection values for microparticles detected by the light detector 104.

For example, the analyzer 105 can correct light detection values received from the light detector 104, and calculate the characteristic amounts of each microparticle. Specifically, the characteristic amounts indicating the size, form, internal configuration, and the like of the microparticle are calculated based on the detection values of the received fluorescent light, forward scattered light and backscattered light. Furthermore, the analyzer 105 may perform sorting determination based on the calculated characteristic amounts and the sorting condition previously received from the input section, and generate a sorting control signal.

The analyzer 105 may not be necessarily included in the microparticle measuring apparatus 100 according to an embodiment of the present technology. The analysis for the states and the like of microparticles can be alternatively performed by an external analysis device or the like based on the light detection value detected by the light detector 104. For example, the analyzer 105 may also be performed by a personal computer or a CPU, or by being stored as a program in a hardware resource containing a recording medium (a nonvolatile memory (such as a USB memory), a HDD, a CD, and the like) to be executed by a personal computer or a CPU. Furthermore, the analyzer 105 may be connected to each constituent component via a network.

(8) Sorting Section 106 (Including Charging Section 1061)

The sorting section 106 includes at least the vibration element 106a that causes droplets to be generated, a deflecting plate 106b that changes the moving direction of charged droplets into a desired direction, and a collecting container that collects droplets. Although the charging section 1061 is separately defined in the context of FIG. 4, it is part of the sorting section 106, and performs charging based on a sorting control signal generated by the analyzer 105.

In the microparticle measuring apparatus 100 of FIG. 4, the vibration element 106a applies vibration to the orifice M1 as described above, thereby generating droplets. The charging section 1061 is connected to the charging electrode section C3 which is linked to the above-described sheath liquid introduction linking section C2, and positively or negatively charges the droplets jetted from the orifice M1 of the microp article measuring chip M based on the sorting control signal generated by the analyzer 105. Then, the moving direction of the charged droplets is changed to a desired direction by the deflecting plate (counter electrode) 106b.

It is noted that the vibration element 106a to be used is not particularly limited, and can be freely selected from known vibration elements. An example thereof may include a piezo vibration element. The size of droplets can be adjusted by adjusting the amount of liquid delivered to the flow channel P, the diameter of a jetting port, the frequency of the vibration element 106a, and the like. Accordingly, droplets each containing a certain amount of microparticles can be generated.

(9) Storage Section 107

The storage section 107 stores all items related to the measurement, such as the values detected by the light detector 104, the characteristic amounts calculated by the analyzer 105, the sorting control signals, and the sorting conditions inputted to the input section.

The storage section 107 may not be necessarily included in the microparticle measuring apparatus 100. Alternatively, an external storage device may be connected to the microparticle measuring apparatus 100. An example of the storage section 107 to be used may include a hard disk. Furthermore, the storage section 107 may be connected to each constituent component via a network.

(10) Display Section 108

The display section 108 can display all items related to the measurement, such as the values detected by the light detector 104, and the characteristic amounts calculated by the analyzer 105. Preferably, the display section 108 can display as a scattergram the characteristic amounts for each microparticle calculated by the analyzer 105.

The display section 108 may not be necessarily included in the microparticle measuring apparatus 100. Alternatively, an external storage device may be connected to the microparticle measuring apparatus 100. Examples of the display section 108 to be used may include a display and a printer.

(11) Input Section 109

The input section 109 is a site for which a user such as an operator operates. A user can access a controller through the input section 109, and control each constituent component of the microparticle measuring apparatus 100 according to an embodiment of the present technology. Preferably, the input section 109 can set a region of interest on the scattergram displayed in the display section to determine the sorting condition.

The input section 109 may not be necessarily included in the microparticle measuring apparatus 100. Alternatively, an external storage device may be connected to the microparticle measuring apparatus 100. Examples of the input section 109 may include a mouse and a keyboard.

(12) Controller 110

The controller 110 can control each of the sample liquid delivering section 101, the fluid controller 102, the light irradiation section 103, the light detector 104, the analyzer 105, the sorting section 106, the charging section 1061, the storage section 107, the display section 108, and the input section 109. The controllers 110 may be separately disposed to the constituent components, and may be disposed externally to the microparticle measuring apparatus 100. For example, the controller 110 may also be performed by a personal computer or a CPU, or by being stored as a program in a hardware resource containing a recording medium (a nonvolatile memory (such as a USB memory), a HDD, a CD, and the like) to be executed by a personal computer or a CPU. Furthermore, the controller 110 may be connected to each constituent component via a network.

(13) Others

The microparticle measuring apparatus 100 according to an embodiment of the present technology can be housed in a biosafety cabinet. Housing in a biosafety cabinet can prevent the dispersal to the surroundings including users and the contamination of a sample. The fluid controller 102 according to an embodiment of the present technology may not be necessary housed in a biosafety cabinet, and can be connected to the microparticle measuring apparatus 100 through the tubes at openings on the wall surface of a biosafety cabinet.

Furthermore, the constituents of the microparticle measuring apparatus 100 are washable in order to prevent the contamination of a sample. In particular, casings which can be brought into contact with a sample, including the sample liquid delivering section 101, the flow channel P, and the sorting section 106, are preferably washable.

Additionally, the present technology may also be configured as below.

(1)

A connecting member to be attached to a substrate that includes at least a sample introduction section to introduce a sample, a sheath liquid introduction section to introduce a sheath liquid, and a jetting section to jet droplets, the connecting member including at least:

a sample introduction linking section to be linked to the sample introduction section;
a sheath liquid introduction linking section to be linked to the sheath liquid introduction section; and
a charging electrode section that provides charges to at least part of the droplets,
wherein the sample introduction linking section and the sheath liquid introduction linking section are positioned so as to be linked to corresponding positions of the substrate.
(2)

The connecting member according to (1), wherein the charging electrode section is contacted to the sheath liquid introduction linking section to provide charges to at least part of the droplets through a sheath liquid.

(3)

The connecting member according to (1) or (2), wherein the charging electrode section includes a connection section that is connected to a charging section, and a contact section that is contacted to the sheath liquid introduction linking section.

(4)

The connecting member according to (3), wherein the connection section and the contact section include metal.

(5)

The connecting member according to any of (1) to (4),

wherein the substrate further includes a suction opening to discharge a drain liquid,
the connecting member further includes a drain liquid linking section to be linked to the suction opening, and
the drain liquid linking section is positioned so as to be linked to a corresponding position of the substrate.
(6)

The connecting member according to any of (1) to (5), wherein the sheath liquid introduction linking section includes a liquid delivering tube to deliver liquid from a sheath liquid delivering section.

(7)

The connecting member according to (6), wherein the liquid delivering tube includes an inter-tube linking section to be directly linked to the sheath liquid delivering section.

(8)

The connecting member according to (7), wherein the inter-tube linking section is configured such that a liquid in the liquid delivering tube is not contacted to outside air.

(9)

The connecting member according to any of (1) to (8), wherein the sample introduction linking section further includes a tube fixing section that fixes a liquid delivering tube to deliver liquid from a sample liquid delivering section.

(10)

The connecting member according to any of (1) to (9), wherein a drain liquid linking section includes a drain liquid tube to discharge liquid to a drain liquid section.

(11)

The connecting member according to any of (1) to (10), further including a positioning mechanism capable of positioning with respect to a microparticle measuring apparatus.

(12)

The connecting member according to (11), wherein the positioning mechanism is a screw fixing mechanism.

(13)

The connecting member according to (12), wherein the connecting member moves in a direction of going away from the substrate when the screw rotates in a direction of being pushed toward the substrate side.

(14)

The connecting member according to any of (1) to (13), further including a chip positioning mechanism capable of positioning a microparticle measuring chip.

(15)

A microparticle measuring apparatus to which the connecting member according to any of (1) to (14) is attached.

(16)

A connecting member to be releasably attached to a substrate that includes at least a sample introduction section to receive a sample, a sheath liquid introduction section to receive a sheath liquid to be merged with the sample to form a laminar flow, and a jetting section to jet droplets of fluid from the laminar flow, the connecting member comprising at least:

a sample introduction linking section configured and positioned to be releasably linked to the sample introduction section of the substrate so as to allow a sample received by the connecting member to pass from the sample introduction linking section to the sample introduction section of the substrate;
a sheath liquid introduction linking section configured and positioned to be releasably linked to the sheath liquid introduction section of the substrate so as to allow a sheath liquid received by the connecting member to pass from the sheath liquid introduction linking section to the sheath liquid introduction section of the substrate; and
a charging electrode section configured and arranged to provide charges from a charging circuit to at least part of the droplets.
(17)

The connecting member according to (16), wherein the charging electrode section is in contact with the sheath liquid introduction linking section to provide charges to at least part of the droplets through the sheath liquid.

(18)

The connecting member according to any of (16) to (17), wherein the charging electrode section includes a connection section that is connected to a charging section, and a contact section that is in contact with the sheath liquid introduction linking section.

(19)

The connecting member according to (18), wherein the connection section and the contact section both include metal.

(20)

The connecting member according to any of (16) to (19), wherein:

the substrate further includes a suction opening to discharge a drain liquid; and
the connecting member further includes a drain liquid linking section configured and positioned to be releasably linked to the suction opening of the substrate so as to allow a drain liquid within the substrate to pass from the suction opening of the substrate to the drain liquid linking section of the connecting member.
(21)

The connecting member according to any of (16) to (20), wherein the sheath liquid introduction linking section includes a liquid delivering tube to deliver liquid from a sheath liquid delivering section.

(22)

The connecting member according to claim (21), wherein the liquid delivering tube includes an inter-tube linking section configured and positioned to be directly linked to the sheath liquid delivering section.

(23)

The connecting member according to (22), wherein the inter-tube linking section is configured such that a liquid in the liquid delivering tube does not contact outside air.

(24)

The connecting member according to any of (16) to (23), wherein the sample introduction linking section further includes a tube fixing section that fixes a liquid delivering tube to deliver liquid from a sample liquid delivering section.

(25)

The connecting member according to (20), wherein the drain liquid linking section includes a drain liquid tube to discharge liquid to a drain liquid section.

(26)

The connecting member according to any of (16) to (25), further comprising a positioning mechanism configured and positioned to accurately position the connecting member with respect to a microparticle measuring apparatus.

(27)

The connecting member according to (26), wherein the positioning mechanism comprises a screw fixing mechanism.

(28)

The connecting member according to (27), wherein the connecting member moves in a direction going away from the substrate when the screw rotates in a direction of being pushed toward the substrate.

(29)

The connecting member according to any of (16) to (28), further comprising a chip positioning mechanism configured and positioned to accurately position a microparticle measuring chip with respect to the connecting member.

(30)

The connecting member of any of (16) to (29), in combination with a microparticle measuring apparatus to which the connecting member is attached.

(31)

The combination of (30), in further combination with the substrate, and in which the sample introduction linking section is releasably linked to the sample introduction section of the substrate, and the sheath liquid introduction linking section is releasably linked to the sheath liquid introduction section of the substrate.

(32)

The combination of (30) or (31), wherein the microparticle sorting apparatus comprises a fluid controller configured to control the introduction of the sheath liquid to the sheath liquid introduction section.

(33)

The combination of (32), wherein:

the substrate further includes a suction opening to discharge a drain liquid;
the connecting member further includes a drain liquid linking section configured and positioned to be releasably linked to the suction opening of the substrate so as to allow a drain liquid within the substrate to pass from the suction opening of the substrate to the drain liquid linking section of the connecting member; and
the fluid controller is further configured to control the discharge of the drain liquid from drain liquid linking section.
(34)

The combination of any of (30) to (33), wherein the microparticle sorting apparatus comprises: a light irradiation section configured to irradiate microparticles of the sample with light; and a light detector to detect light generated from the microparticles in response to the light from the light irradiation section.

(35)

The combination of (34), wherein the microparticle sorting apparatus further comprises an analyzer configured to analyze light detected by the light detector to identify at least one characteristic of the microparticles in the sample.

(36)

The combination of any of (35), wherein the microparticle sorting apparatus further comprises:

a sorting section including a vibration element configured to cause droplets to be generated from the laminar flow; and
a deflector configured to change a moving direction of droplets to which charges were added via the charging electrode section of the connecting member based on a sorting control signal generated by the analyzer.
(37)

The combination of any of (30) to (35), wherein the microparticle sorting apparatus further comprises:

a sorting section including a vibration element configured to cause droplets to be generated from the laminar flow; and
a deflector configured to change a moving direction of droplets to which charges were added via the charging electrode section of the connecting member.

### REFERENCE SIGNS LIST

C connecting member
C1 sample introduction linking section
C11 liquid delivering tube to deliver liquid from sample liquid delivering section
C111 tube fixing section
C2 sheath liquid introduction linking section
C21 liquid delivering tube to deliver liquid from sheath liquid delivering section
C3 charging electrode section
C31, C32 connection section
C33 contact section
C4 drain liquid linking section
C41 drain liquid tube to discharge liquid into drain liquid section
100 microparticle measuring apparatus
101 sample liquid delivering section
102 fluid controller
103 light irradiation section
104 light detector
105 analyzer
106 sorting section
106a vibration element
106b deflecting plate
1061 charging section
107 storage section
108 display section
109 input section
110 controller
1 sheath liquid delivering section
10 sheath liquid housing section
11 support
12 sealing section
2 sheath liquid delivering tube
3 drain liquid section
4 mounting board
P flow channel
M microparticle measuring chip
Ma, Mb substrate layer
M1 orifice
M11 cutout
M2 sample flow channel
M3 sample introduction section
M4 sheath liquid introduction section
M5 suction flow channel
M51 suction opening
M52 communication opening
M61, 62 narrowing portion
M7 straight portion
L1 diameter of cutout M11
L2 opening diameter of orifice M1

1. A connecting member to be releasably attached to a substrate that includes at least a sample introduction section to receive a sample, a sheath liquid introduction section to receive a sheath liquid to be merged with the sample to form a laminar flow, and a jetting section to jet droplets of fluid from the laminar flow, the connecting member comprising at least:
a sample introduction linking section configured and positioned to be releasably linked to the sample introduction section of the substrate so as to allow a sample received by the connecting member to pass from the sample introduction linking section to the sample introduction section of the substrate;
a sheath liquid introduction linking section configured and positioned to be releasably linked to the sheath liquid introduction section of the substrate so as to allow a sheath liquid received by the connecting member to pass from the sheath liquid introduction linking section to the sheath liquid introduction section of the substrate; and
a charging electrode section configured and arranged to provide charges from a charging circuit to at least part of the droplets.

2. The connecting member according to claim 1, wherein the charging electrode section is in contact with the sheath liquid introduction linking section to provide charges to at least part of the droplets through the sheath liquid.

3. The connecting member according to claim 1, wherein the charging electrode section includes a connection section that is connected to a charging section, and a contact section that is in contact with the sheath liquid introduction linking section.

4. The connecting member according to claim 3, wherein the connection section and the contact section both include metal.

5. The connecting member according to claim 1, wherein:
the substrate further includes a suction opening to discharge a drain liquid; and
the connecting member further includes a drain liquid linking section configured and positioned to be releasably linked to the suction opening of the substrate so as to allow a drain liquid within the substrate to pass from the suction opening of the substrate to the drain liquid linking section of the connecting member.

6. The connecting member according to claim 1, wherein the sheath liquid introduction linking section includes a liquid delivering tube to deliver liquid from a sheath liquid delivering section.

7. The connecting member according to claim 6, wherein the liquid delivering tube includes an inter-tube linking section configured and positioned to be directly linked to the sheath liquid delivering section.

8. The connecting member according to claim 7, wherein the inter-tube linking section is configured such that a liquid in the liquid delivering tube does not contact outside air.

9. The connecting member according to claim 1, wherein the sample introduction linking section further includes a tube fixing section that fixes a liquid delivering tube to deliver liquid from a sample liquid delivering section.

10. The connecting member according to claim 5, wherein the drain liquid linking section includes a drain liquid tube to discharge liquid to a drain liquid section.

11. The connecting member according to claim 1, further comprising a positioning mechanism configured and positioned to accurately position the connecting member with respect to a microparticle measuring apparatus.

12. The connecting member according to claim 11, wherein the positioning mechanism comprises a screw fixing mechanism.

13. The connecting member according to claim 12, wherein the connecting member moves in a direction going away from the substrate when the screw rotates in a direction of being pushed toward the substrate.

14. The connecting member according to claim 1, further comprising a chip positioning mechanism configured and positioned to accurately position a microparticle measuring chip with respect to the connecting member.

15. The connecting member of claim 1, in combination with a microparticle measuring apparatus to which the connecting member is attached.

16. The combination of claim 15, in further combination with the substrate, and in which the sample introduction linking section is releasably linked to the sample introduction section of the substrate, and the sheath liquid introduction linking section is releasably linked to the sheath liquid introduction section of the substrate.

17. The combination of claim 15, wherein the microparticle sorting apparatus comprises a fluid controller configured to control the introduction of the sheath liquid to the sheath liquid introduction section.

18. The combination of claim 17, wherein:
the substrate further includes a suction opening to discharge a drain liquid;
the connecting member further includes a drain liquid linking section configured and positioned to be releasably linked to the suction opening of the substrate so as to allow a drain liquid within the substrate to pass from the suction opening of the substrate to the drain liquid linking section of the connecting member; and
the fluid controller is further configured to control the discharge of the drain liquid from drain liquid linking section.

19. The combination of claim 15, wherein the microparticle sorting apparatus comprises:
a light irradiation section configured to irradiate microparticles of the sample with light; and
a light detector to detect light generated from the microparticles in response to the light from the light irradiation section.

20. The combination of claim 19, wherein the microparticle sorting apparatus further comprises an analyzer configured to analyze light detected by the light detector to identify at least one characteristic of the microparticles in the sample.

21. The combination of claim 20, wherein the microparticle sorting apparatus further comprises:
a sorting section including a vibration element configured to cause droplets to be generated from the laminar flow; and
a deflector configured to change a moving direction of droplets to which charges were added via the charging electrode section of the connecting member based on a sorting control signal generated by the analyzer.

22. The combination of claim 15, wherein the microparticle sorting apparatus further comprises:
a sorting section including a vibration element configured to cause droplets to be generated from the laminar flow; and
a deflector configured to change a moving direction of droplets to which charges were added via the charging electrode section of the connecting member.
